(19) United States
(12) Patent Application Publication
(10) Pub. No.: US 2026/0009985 A1
(43) Pub. Date: Jan. 8, 2026

(54) HIGHLY STABLE TWO-MIRROR OPTICAL CAVITY WITH DIRECT INJECTION

(71) Applicant: City University of Hong Kong, Kowloon (HK)

(72) Inventors: Juan Antonio Zapien, Shatin (HK); Yee Man Kwong, Tai Kok Tsui (HK); Md Rashedul Huqe, Hung Hom (HK)

(21) Appl. No.: 19/240,292

(22) Filed: Jun. 17, 2025

Related U.S. Application Data
(60) Provisional application No. 63/667,292, filed on Jul. 3, 2024.

(51) Int. Cl. G02B 17/06; G02B 5/08

(52) U.S. Cl. CPC G02B 17/0621; G02B 5/08

(57) ABSTRACT

A two-mirror assembly, which includes a first mirror which is an aspherical mirror, a second mirror located away from the first mirror, and an open cavity formed between the first mirror and the second mirror. Embodiments of the invention provide open cavities that are stable cavities including a direct injection stability and a real ray stability.

### FIELD OF INVENTION

This invention relates to optical cavities in optical systems, in particular to two-mirror optical cavities.

### BACKGROUND OF INVENTION

Optical cavities are fundamental components in optical systems for a number of applications ranging from optical delays to increased light-matter interaction to electromagnetic energy storage and modulation. In general, optical cavities can be categorized as stable, marginally stable, or unstable based on the reflected light's confinement within the cavity which is usually represented in a stability diagram. In a stable cavity, the reflected light remains confined within the cavity even after an infinite number of reflections. In an unstable cavity, the reflected light continuously diverges as the number of reflections increases. This divergence causes the beam size to expand until it becomes larger than the reflectors, thereby allowing the light to escape the system [1]. Cavity instability can also arise when the beam walks-out of the mirror's intended trajectory due to the global effect of the shifts in positions that occur at each reflection.

Symmetric cavities like flat mirrors and spherical cavities (confocal/concentric) are categorized as marginally stable cavities because small variations in the cavity length or alignment can cause the cavity to become unstable. In a confocal cavity, the displacement of a ray deviating from its original direction from cavity axis is greater after reflecting from one of the mirrors compared to other cavity designs. Also, this stability calculated is based on paraxial approximation, which means holding the assumption of small angles with the optical axis and remaining close to it throughout an optical system [2].

The mechanism for light injection into an optical cavity is of vital importance for its overall performance and efficiency. This is typically achieved by one of the three known methods: i) energy pumping, ii) semi-transparent mirror, or iii) direct injection. However, the use of the first two mechanisms, energy pumping, and semi-transparent mirror, incur large energy losses when the light enters the cavity. For direct injection, the most efficient mechanism, there are three common types of cavities that are routinely used: Pfund Cell, Herriott cell, and White cell [3]. The Pfund Cell and the Herriott cell [4] employ two mirrors (identical spherical and opposing spherical), with at least one of them containing a hole. The white cell utilizes three spherical, concave mirrors. However, in all these strategies, the rays eventually escape-which means they are unstable cavities.

### REFERENCES

Each of the following references (and associated appendices and/or supplements) is expressly incorporated herein by reference in its entirety:
[1] H. J. Eichler, J. Eichler, and O. Lux, Lasers Basics, Advances and Applications, vol. 220. Springer, 2018. [Online]. Available: https://link.springer.com/chapter/10.1007/978-3-319-99895-4_10
[2] H. Kogelnik and T. Li, “Laser Beams and Resonators,” Proc. IEEE, vol. 54, no. 10, pp. 1312-1329, 1966, doi: 10.1109/PROC.1966.5119.
[3] J. U. White, “Long Optical Paths of Large Aperture,” J. Opt. Soc. Am., vol. 32, no. 5, p. 285, 1942, doi: 10.1364/josa.32.000285.
[4] D. R. Herriott and H. J. Schulte, “Folded Optical Delay Lines,” Appl. Opt., vol. 4, no. 8, p. 883, 1965, doi: 10.1364/ao.4.000883.
[5] D. H. Reinhart Poprawe, Konstantin Boucke, Ed., Tailored Light 1: High Power Lasers for Production. Springer US, 2011. [Online]. Available: http://www.springerlink.com/index/10.1007/978-3-642-01237-2
[6] Q. Gao, Y. Zheng, L. Wang, C. Li, J. Zhang, H. Wu, Y. Han, and S. Wang, “Designing a Long Optical Path Direct-Injection-Integrated Cavity for Laser Absorption Spectroscopy,” Photonics, vol. 11, no. 1, 2024, doi: 10.3390/photonics11010036.
[7] V. Kaloshin and A. Sorrentino, “On the integrability of birkhoff billiards,” Philos. Trans. R. Soc. A Math. Phys. Eng. Sci., vol. 376, no. 2131, pp. 155-156, 2018, doi: 10.1098/rsta.2017.0419.
[8] G. Huang, “On the Integrability of Strictly Convex Billiard Tables with Boundaries Close to Ellipses with Small Eccentricities,” Acta Math. Sin. Engl. Ser., vol. 38, no. 1, pp. 55-67, 2022, doi: 10.1007/s10114-022-0153-3.
[9] D. Hilbert, Geometry and Imagination. 1952.
[10] H. Stachel, “Reflection in quadratic surfaces,” Ann. Math. Informaticae, vol. 48, pp. 51-64, 2018.
[11] H. Waalkens, J. Wiersig, and H. R. Dullin, “Triaxial Ellipsoidal Quantum Billiards,” Ann. Phys. (N. Y)., vol. 276, no. 1, pp. 64-110, 1999, doi: 10.1006/aphy.1999.5936.
[12] D. Z. Anderson, “Alignment of resonant optical cavities,” Appl. Opt., vol. 23, no. 17, p. 2944, 1984, doi: 10.1364/ao.23.002944.
[13] Y. Liu and Y. Ma, “Advances in multipass cell for absorption spectroscopy-based trace gas sensing technology [Invited],” Chinese Opt. Lett., vol. 21, no. 3, p. 033001, 2023, doi: 10.3788/col202321.033001.

### SUMMARY OF INVENTION

Accordingly, the present invention in one aspect provides a mirror assembly, which includes a first mirror which is an aspherical mirror, a second mirror located away from the first mirror, and an open cavity formed between the first mirror and the second mirror.

In some embodiments, the first mirror is a segment of a virtual ellipsoid that does not possess rotational symmetry.

In some embodiments, the segment is centered at an intersection of a major axis and a minor axis of the ellipsoid.

In some embodiments, the ellipsoid is a three-axis ellipsoid with three axes that are different in length between each other.

In some embodiments, the open cavity has a caustic shape of a hyperbolic paraboloid.

In some embodiments, ray trajectories within the open cavity are guided by the caustic shape in directions perpendicular to an optical axis of the open cavity.

In some embodiments, a caustic of the open cavity oscillates in a major direction of the ellipsoid as well as in a minor direction of the ellipsoid that is perpendicular to the major direction.

In some embodiments, the second mirror is an aspherical mirror.

In a further aspect of the invention, there is provided a two-mirror assembly, which includes a first mirror; a second mirror located away from the first mirror; and an open cavity formed between the first mirror and the second mirror.

In some embodiments, at least one of the first and second mirrors is an aspherical mirror.

In some embodiments, the first mirror is a segment of an ellipsoid which is centered at an intersection of a major axis and a minor axis of the ellipsoid.

In some embodiments, the open cavity has a caustic shape of a hyperbolic paraboloid.

In some embodiments, the ellipsoid does not possess rotational symmetry.

In some embodiments, a caustic of the open cavity oscillates in a major direction of the ellipsoid as well as a minor direction of the ellipsoid that is perpendicular to the major direction.

According to another aspect of the invention, there is provided an open cavity which includes a caustic having shape of a hyperboloid of two sheets. The caustic oscillates only in a minor axis direction of an ellipsoid. The ellipsoid is produced by revolving an ellipse about the major axis.

According to a further aspect of the invention, there is provided an open cavity which includes a caustic having shape of a hyperboloid of one sheet. The caustic oscillates in two minor axis directions of an ellipsoid. The ellipsoid is produced by revolving an ellipse about the minor axis.

According to a further aspect of the invention, there is provided an open cavity which includes a caustic having shape of a hyperbolic paraboloid. The caustic oscillates in a major direction of the ellipsoid as well as a minor direction of the ellipsoid that is perpendicular to the major direction. The ellipsoid has no rotational symmetry.

According to a further aspect of the invention, there is provided a mirror assembly, which includes at least one aspherical mirror being a segment of an ellipsoid without rotational symmetry. The mirror is configured to produce a caustic shape within a cavity, the caustic shape guiding ray trajectories to confine light within the cavity.

In some embodiments, the ellipsoid is a three-axis ellipsoid without rotational symmetry, having three distinct axes.

In some embodiments, the at least one aspherical mirror includes a first mirror, and a second mirror positioned at a distance from the first mirror, forming the cavity between the first mirror and the second mirror.

In some embodiments, the cavity is an open cavity configured to confine injected light and prevent the rays from retracing their path and escaping through the injection hole, due to the ellipsoid's asymmetric geometry.

In some embodiments, the ray trajectories are guided by the caustic shape in directions perpendicular to an optical axis of the cavity.

In some embodiments, the open cavity achieves high stability, preventing beam divergence beyond the mirror boundaries and path escape through the injection hole.

In some embodiments, the at least one aspherical mirror is fabricated to match the geometry of the ellipsoid without rotational symmetry.

One can see that embodiments of the invention therefore provide open cavities that are stable cavities including a direct injection stability and a real ray stability. The open cavities can tolerate multi type of alignment errors reported in traditional type cavity. And it results in real ray stability (large angle to optical axis) instead of paraxial ray stability (small angle to optical axis). It is shown that the open cavity design performs remarkably close to an ideal closed cavity. Accordingly, some embodiments of the invention provide mirror assemblies including an aspherical mirror that is constructed with the middle sections of a three-axis ellipsoid without rotational symmetry, and the aspherical mirror may be paired with either an identical mirror or a flat mirror to form the mirror assembly. This configuration leverages the three-axis ellipsoid's unique curvature to prevent light escape outside the mirror boundaries, ensuring high stability even in direct-injection systems. This geometry, unlike traditional spherical or planar mirrors, provides a robust reflective environment that maintains light confinement across multiple reflections, making it ideal for applications requiring sustained intensity, such as spectroscopy and photocatalysis.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 illustrates a two-mirror assembly according to a first embodiment of the invention, as well as a light source and a light detector.

FIG. 2 illustrates a segment of an ellipsoid selected and fabricated as an aspherical mirror in the two-mirror assembly of FIG. 1.

FIG. 3 shows the performance of an ideal closed cavity was calculated by an infinite geometric series and plotted as a function of reflectivity (R), with the data terminated at 10%. (a) Number of reflections. (b) Normalized power gain.

FIG. 4 illustrates caustics in a non-rotational symmetry tri-axis ellipsoid system and developed into an open optical cavity.

FIG. 5 illustrates the use of a flat mirror (the central thick solid line), which has the same trajectories as mirror cavity' half trajectories (the top and bottom thick solid lines).

FIG. 6 illustrates possible misalignments of the incident ray axis (solid line) compared to the cavity axis (dashed line). (a) Rotation (b) lateral displacement (c) mismatch of waist size, and (d) waist displacement. Among all, (a) is sensitive to flat cavity and (b-d) are sensitive to spherical cavity. (e) a combination of all types of misalignments, which represent as a cone of light emitted from the first mirror.

FIG. 7 illustrates ray trajectories of two-mirror cavities, a cone of light emitted from the first mirror, which represented a combination of misalignment mentioned in FIG. 6. (a) Flat mirror cavity and (b) concave cavity exhibits ray escape and instability due to combination of misalignments. In contrast, an optical cavity (c) according to an embodiment of the invention is designed to tolerate misalignments, ensuring stability.

FIG. 8 illustrates simulation of 10,000 reflections in a 2D two-mirror cavity, constructed by 5 cm length elliptical middle segment. The zoomed-in view of the hitting edge reveals non-overlapping hitting points, indicating that light will not escape if the injection hole is small enough.

FIG. 9 shows performance comparison of conventional flat cavity and an optical cavity according to an embodiment of the inventio (label as “novel cavity” in FIG. 9) under highly diverse light conditions. (a) The first 14 reflections spot diagram on the front mirror is shown (b) Ray is escaping the cavity after 4th reflection. (c) The power gain is normalized at R=0. And they are divided by the ideal cavity gain.

FIG. 10 illustrates that (a) a 2-inch area segment of ellipsoid is selected and fabricated as a mirror; (b) in the photograph of the mirror, coated with Al and SiO₂, a 3 mm hole is drilled in the middle; (c) the roughness of the aspherical mirror is measured by white light interferometry, and (d) it compares the experimental and modelling errors in terms of surface curvature.

FIG. 11 shows (a) measurement setup (b) reflectivity of M1 and M2 (c) performance as a function of mirror distance.

### DETAILED DESCRIPTION

Open optical cavities are crucial for light-matter interaction, however conventional designs suffer from instability and light leakage. To address these shortcomings, exemplary embodiments of the invention provide an aspherical mirror that enables the construction of a highly stable two-mirror optical cavity with direct light injection. It is shown that this open cavity design performs remarkably close to an ideal closed cavity. The confinement ability is experimentally demonstrated with respect to mirror distance, and confirms a five-time intensity enhancement, with a modest reflectance value of R=0.94, for a combination of flat and aspherical mirrors compared to the use of standard flat and concave mirrors. The aspherical mirror design is beneficial for applications including cavity-enhanced optical sensing, photochemistry, open flow photocatalysis, and other applications where enhanced light-matter interaction are needed under fast or continuous flow of matter.

Turning to FIG. 1, in a first embodiment of the invention there is provided a two-mirror assembly 20, which includes a first mirror 22 and a second mirror 24 that is separated from the first mirror 22. An optical cavity 30 is created between the first mirror 22 and the second mirror 24, allowing light rays injected into the optical cavity 30 to propagate through the region between the first mirror 22 and the second mirror 24. Both of the first mirror 22 and the second mirror 24 have substantially round shapes. The first mirror 22 is an aspherical mirror, while the second mirror 24 is a flat mirror. However, in other embodiments, the second mirror 24 may also be an aspherical mirror, for example an identical one as the first mirror 22. The first mirror 22 has an injection hole 22a which is a through hole formed at the center of the first mirror 22. Also shown in FIG. 1 is a light source 26 and a light detector 28 external to the two-mirror assembly 20, which are used in a measurement setup which will be described in more detail later.

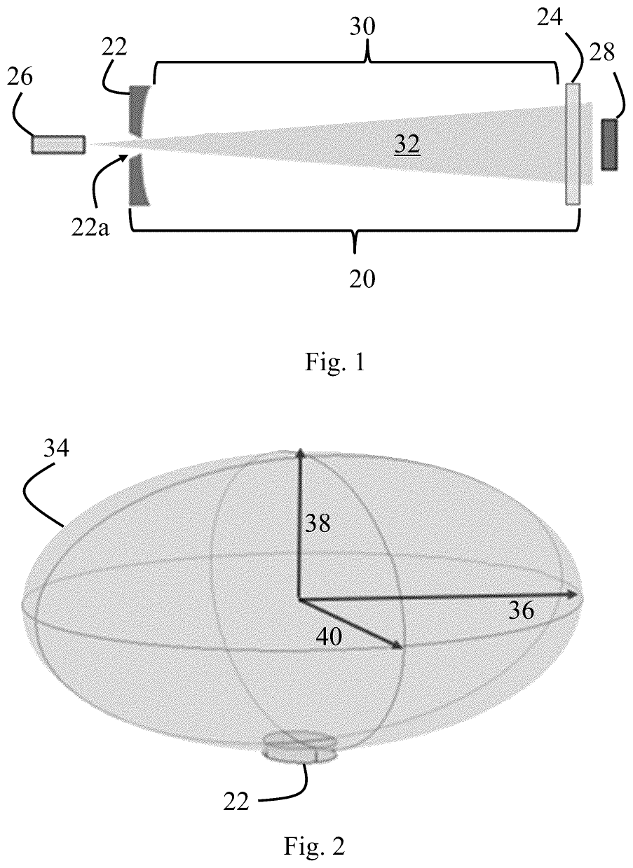

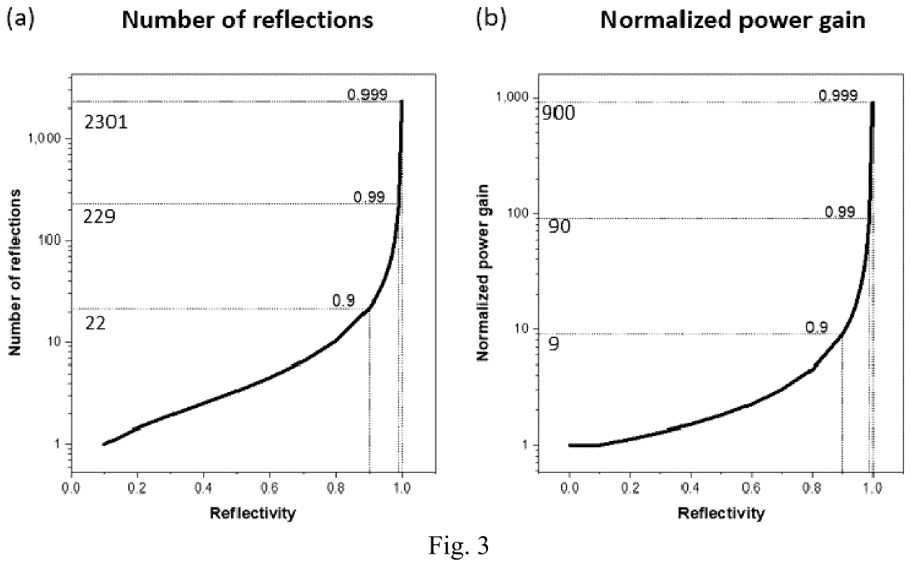

The first mirror 22 may be fabricated from a segment of an ellipsoid. FIG. 2 shows a virtual ellipsoid 34 which has a geometrical shape matching the radius curvature of the first mirror 22. Note that the injection hole 22a of the first mirror 22 is not shown in FIG. 2. In particular, the ellipsoid 34 is a three-axis ellipsoid, which is defined by a major axis 36, a minor axis 40, and a mean axis 38. All three axes have different lengths, with the major axis 36 being the longest and the minor axis 40 being the shortest. The ellipsoid 34 does not possess rotational symmetry. As mentioned above, the first mirror 22 may be fabricated from a segment of an ellipsoid, and the virtual ellipsoid 34 will then overlap with the actual ellipsoid from which the first mirror 22 is fabricated.

Since the first mirror 22 is an aspherical mirror being a segment of the ellipsoid 34 without rotational symmetry, the first mirror 22 produces a caustic shape within the optical cavity 30, where the caustic shape is adapted to guides ray trajectories to substantially confine light 32 from the light source 26 to be within the optical cavity 30. In other words, the optical cavity 30 which is an open cavity is configured to confine injected light 32 and prevent light rays from retracing their path and escaping through the injection hole 22a, due to the asymmetric geometry of the ellipsoid 34. The ray trajectories are guided by the caustic shape in directions perpendicular to an optical axis (not shown) of the optical cavity 30. As will be described in detail later, the optical cavity 30 achieves high stability, preventing beam divergence beyond the mirror boundaries and path escape through the injection hole 22a. The two-mirror assembly 20 in FIG. 1 therefore provides a highly stable two-mirror optical cavity with direct light injection, enabled by an innovative aspherical mirror informed by billiard theory.

### Mirror Cavity Design Theory

In this section, the principles of light confinement will be outlined, using billiard theory to address open cavity challenges and introducing the aspherical mirror's unique geometry.

In an ideal optical cavity, light is confined, and its intensity increases until it reaches a stable equilibrium, where energy input balances energy loss, maintaining a constant intensity level [1]. In the absence of thermodynamic effects, the total power gain can be approximated using an infinite geometric series, given by

$$S = \frac{1}{( 1 - R )} ,$$

where S is the power sum of the series and r is the reflectivity [5]. For numerical simulations, an infinite number of reflections is impractical, so a termination condition is set. Here, we define the cut-off at 10% of the initial power, where the number of reflections (N) is calculated as

$$N = \frac{log ( 0.1 )}{log ( R )}$$

and the corresponding power sum, considering reflections above 10%, is by

$$S = \frac{1 - {R}^{N}}{( 1 - R )} .$$

FIG. 3 illustrates he performance of an ideal closed cavity was calculated by an infinite geometric series and plotted as a function of reflectivity (R), with the data terminated at 10%. (a) Number of reflections. (b) Normalized power gain.

However, even neglecting thermodynamic and diffraction effects, an ideal geometrical optical cavity with perfect reflectivity R=1 is unattainable due to two primary loss mechanisms in a two-mirror cavity. First, beam divergence, resulting from imperfect collimation, causes the beam to expand beyond the mirrors, leading to light escape. Second, the ray path contributes to loss: an open path reaches the system's edge, exiting the cavity, while a closed path returns to the injection point, escaping through the injection hole [6].

To address the first loss mechanism, one can make use of the integrability of billiards. Integrable billiards are characterized by the combination of all caustics forming a set with a non-empty interior. The concept of integrable billiards can be related to the idea of confinement in optics. When there is no region for the paths of light rays to cross or overlap, it means that the light is confined within a specific region or structure [7]. Birkhoff conjectured that the only integrable billiards with smooth boundaries are the circle and the ellipse. The 1-foci-ellipse is the circle, and the 2-foci-ellipse is the classic ellipse.

To address the second loss mechanism, one can make use of the quasiperiodic orbits. The rotation number, as defined in the Aubry-Mather theorem, is used to determine the nature of quasiperiodic orbits. The rotation number measures how a trajectory winds around a torus and determines if the motion is quasiperiodic. The rotation number (f) is defined as winding number (p) divided by the number of reflections (q), that is f=p/q. If the rotation number is an irrational number, the orbit is considered quasiperiodic [8]. In a quasi-periodic cavity, the ray trajectories appear to follow a regular pattern but lack a fixed period. This unique characteristic ensures that the light never retraces its path and, therefore, theoretically never escapes the cavity.

In an ellipse, there is only a pair of foci, f₁=±\sqrt{a²−b²}, 0. Ellipses exhibit three types of trajectories: focal, elliptic, and hyperbolic [7]. When a path passes through one of the focal points, it oscillates between the two focal points and eventually converges to the major axis. In cases where the path intersects the major axis beyond the segment connecting the focal points, it is confined within an ellipse that shares the same focal points. Conversely, if the path intersects the major axis between the focal points, it is enclosed by a hyperbola with identical focal points. The application of hyperbolic caustics can be utilized in constructing an elliptical two-mirror cavity.

In an ellipsoid, there are three axes as mentioned above, which are the major, the mean, and the minor. Staude's thread construction for the ellipsoid utilizes a fixed framework comprising an ellipse and a hyperbola. The hyperbola's plane is perpendicular to the ellipse's plane and intersects the main axis of the ellipse. Each ellipsoid has its focal curves (focal ellipse and focal hyperbola), and they are used to define the foci [9].

TABLE 1
Summary of ellipse and ellipsoid coordinates [10].

| | R² (Ellipse) | R³ (Ellipsoid) |
|---|---|---|
| Cartesian coordinates | $\{ \begin{matrix}x = a cos t \\ y = b sin t\end{matrix}$ | $\{ \begin{matrix}x = a cos s sin t \\ y = b sin s sin t \\ z = c cos t\end{matrix}$ |

Table 1 summaries the cartesian coordinates of ellipse and ellipsoid. In an ellipse, a and b are the semi-axes representing the lengths along the x and y axes respectively. The variable t is an angle parameter that determines the position of a point on the ellipse. In an ellipsoid, a, b, and c represent the semi-axes along the x, y, and z axes respectively, while the parameters s and t control the rotations around the x and z axes respectively, enabling adjustments to the ellipsoid's orientation and shape.

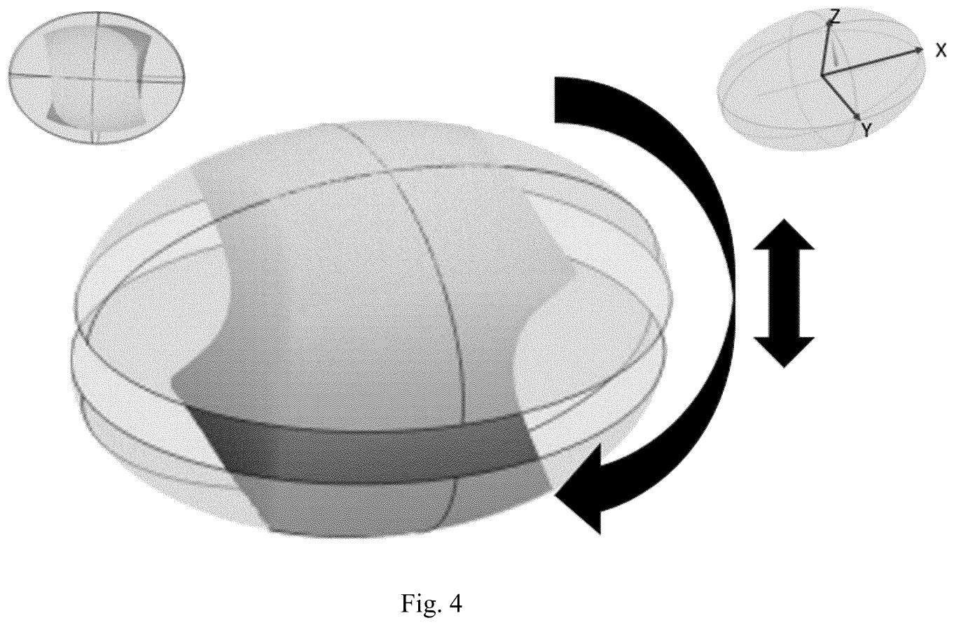

In a triaxial ellipsoid, different types of caustics are identified based on the study of invariant 3-tori [11]. These tori are used to describe the particle's motion in phase space, which represents all possible states of a system. In general, for an ellipsoid which does not possess rotational symmetry, any trajectory that intersects the ellipsoid will form a caustic hyperbolic paraboloid. The paraboloid oscillates between caustics in the Y and Z directions, allowing it to be developed into a two-mirror cavity, as shown in FIG. 4. Furthermore, this caustic also possesses rotational properties, enabling different ray patterns to be achieved through mirror rotation.

### Mirror Cavity Analysis

In this section, the development of a two-mirror cavity with rotational modulation using the caustic is described. The stability and quasi-periodic features are discussed, and a comparison with other cavity designs is provided.

To develop caustic D into a two-mirror cavity, the process begins by selecting an edge center segment surface of the triaxial ellipsoid and constructing it as a mirror. This mirror serves as one side of the cavity. The other side of the cavity can be either another mirror identical to the first one or a flat mirror.

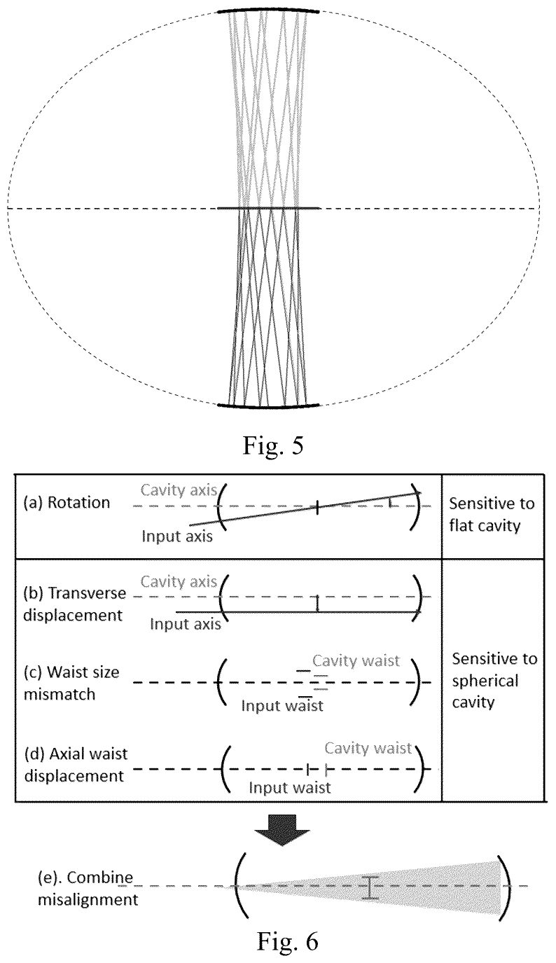

In FIG. 5, it is shown that the use of a flat mirror is possible due to the symmetry of the ellipsoid, which is similar to the semi-confocal resonator arrangement. This arrangement involves placing a flat mirror with an infinite radius of curvature (R2=∞) at the location of the beam waist of the first mirror. The ellipsoid's symmetry ensures that the beam waist, denoted as w0, is located at the minimum beam waist position.

Next, the stability problem of the traditional cavity and the optical cavity according to an embodiment of the invention are addressed. Stability diagram this is a graphical representation used to analyse the stability of an optical cavity or resonator, it plots the stability parameters, g1 and g2. where

$${g}_{1} = 1 - \frac{L}{{R}_{1}} and {g}_{2} = 1 - \frac{L}{{R}_{2}} .$$

R1 and R2 are the mirrors' radius curvature and L is the distance between the mirrors. In this case a stable cavity is defined when 0≤g₁g₂≤1; while unstable cavity occurs outside this range. It is crucial to avoid misconceptions when using the term “unstable” in this context, as configurations described as such can still possess robustness and exhibit low sensitivity to alignment. Conversely, stable resonators are highly susceptible to disturbances such as thermal lensing or misalignment [1]. Symmetric cavities, such as flat mirrors and spherical cavities (confocal/concentric), are positioned at the boundaries of the stability diagram and are classified as marginally stable or conditionally stable. They are only stable if the mirrors are perfectly aligned [2].

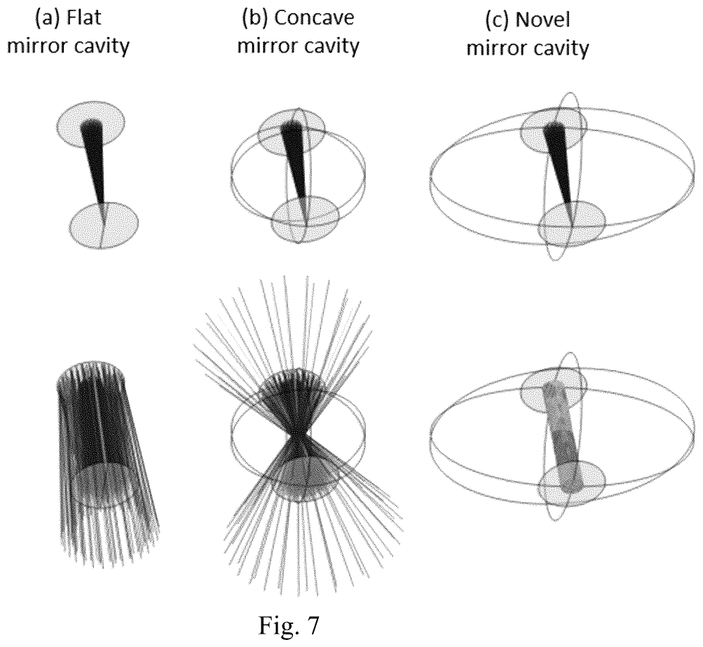

In FIG. 6, for a two-mirror cavity, there are four parameters that describe the input beam alignment: (a) tilt; (b) lateral displacement; (c) mismatch of waist size and (d) waist displacement [12]. A cavity consisting of two planar mirrors arranged in a plane-plane configuration demonstrates the most significant sensitivity to mirror tilt. On the other hand, spherical cavities are exceptionally responsive to variations in the g parameter, which corresponds to changes in the resonator length L or mirrors curvature [5]. A cone light emitted from the first mirror is therefore considered a combination of multiple misalignments and is thus sensitive to traditional design. In FIG. 7, it shows the ray tracing of a flat mirror cavity, concave mirror cavity, and an aspherical mirror cavity according to an embodiment of the invention. The flat and concave mirror cavities exhibit a significant amount of ray escape, making them unstable cavities. On the other hand, the aspherical mirror cavity still maintains very good confinement.

It is widely recognized that all unstable cavities, which permit light ejection, will ultimately result in the light escaping. This is a fundamental trait of such systems [6]. Over time, researchers have tried to address this issue by adding more mirrors to these cells to increase the optical path length [13]. However, this solution has its limitations, as it significantly increases the system's complexity, making it more difficult to design, construct, and maintain.

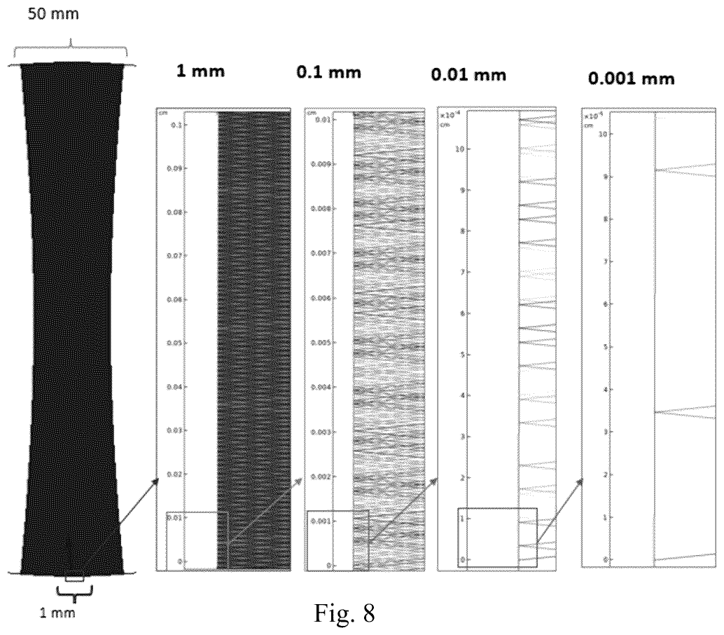

The aspherical mirror cavity cavity, characterized by its quasi-periodic feature, offers a promising alternative to the stability problem of traditional cavities. In FIG. 8, 10,000 reflections in a 2D ellipse segment is simulated and its hitting points are analysed. It showed that the hitting points don't overlap, suggesting that as long as the injection hole is small enough, the light will continue to bounce within the cavity indefinitely. This unique characteristic of the aspherical mirror cavity not only ensures a long optical path length but also simplifies the system's design and operation.

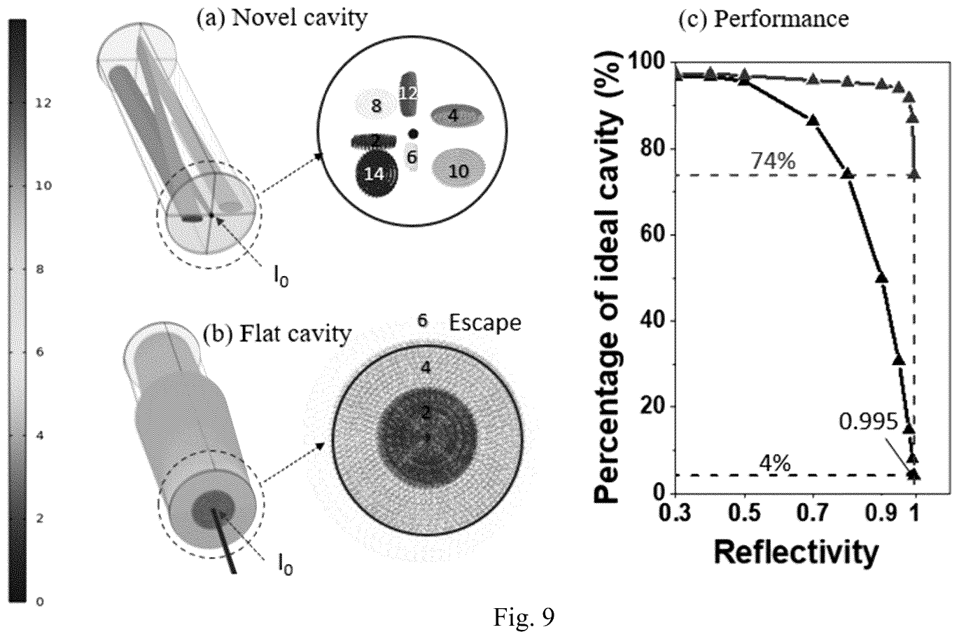

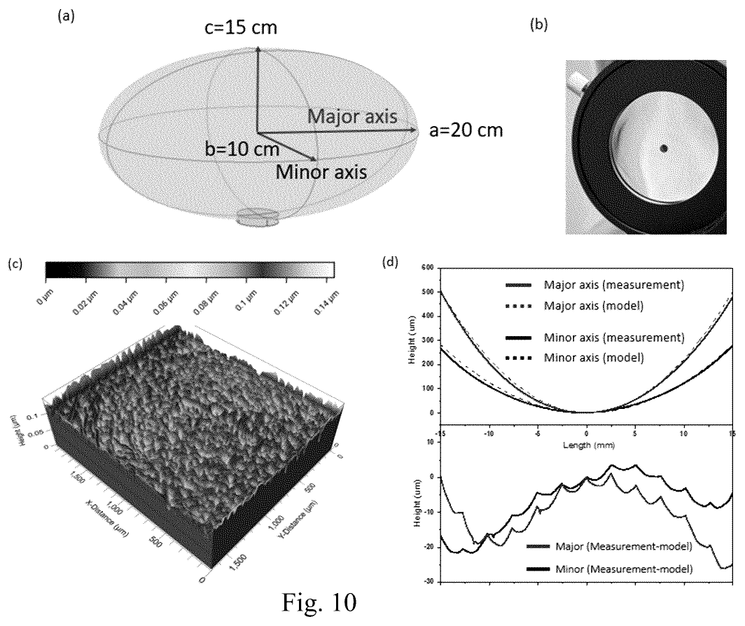

Here, the aspherical mirror performance is qualified by a numerical computational approach, as show in FIG. 9. The ray release is defined, and thus, the initial ray coordinates and wave vector are applied as variables to solve Hamilton equations. These results are qualified by computing the fluence rate, which is defined as the amount of radiation that a tiny spherical detector would be exposed to at any point in space, divided by the cross-sectional area of such a detector.

Throughout the computation, the volumetric fluence rate is calculated as the rays propagate through the cylindrical region between the two mirrors. The power gain is then normalized based on a reflectivity of zero. The termination criterion for the rays is set at a power level below 10%. The study compares the performance of the aspherical mirror cavity with a flat cavity using highly diverse light (full cone angle of 3.4 deg). The mirror size is fixed at 50.8 mm, while the beam size and hole size are set at 2 mm and 2.4 mm, respectively, which are common.

For the flat mirror cavity, the emitted light from the centered hole with a perpendicular ray direction vector with a non-zero component in the direction perpendicular to the cavity axis will result in partial light escaping through the hole. As the number of reflections increases, the light forms radiating spots on the mirror and eventually escapes the cavity via multiple directions as shown in FIG. 9(b).

In contrast, for the aspherical mirror cavity, the emitted light originates from the center, the ray direction vector is slightly tilted, causing the first hitting point to be around the edge of the opposite mirror. The only mechanism for ray escape is through the centered hole, since it is not infinitely small.

The findings are presented in FIG. 9, where the ideal cavity power enhancement is calculated using an infinite geometric series. The normalized enhancement factors for the ideal case, as well as for the flat cavity and the aspherical mirror cavity, are obtained. The percentage of the ideal cavity achieved is then calculated by dividing the normalized enhancement factor of the flat cavity or the aspherical mirror cavity by the ideal case. The graph illustrates that at R=0.995, the flat mirror can only achieve approximately 4% of the ideal cavity power enhancement, while the aspherical mirror can achieve around 74%, even for highly divergence cases, respectively.

### D. Experimental Result

This section will present and discuss simulations and experimental results that validate the cavity's superior confinement and intensity enhancement compared to traditional flat and concave mirror designs. The cavity's performance is simulated, and the process of focusing the output beam is explained. The experimental part focuses on the mirror manufacturing process, presenting data on reflectivity and roughness.

The process of fabricating the mirror begins with FIG. 10(a), which displays an ellipsoid with dimensions a:b:c=10:15:20 in cm. A 2-inch area segment is then selected, centered at the intersection point of the major and minor axes. FIG. 10(b) shows the resulting mirror obtained through the fabrication process. Initially, a computer numerical control (CNC) technique is employed to create the glass molding, which is then used to manufacture the glass substrate. A 3-mm diameter hole is drilled into the glass. Subsequently, an Al+SiO₂ layer is coated onto the substrate using E-Beam Deposition. In FIG. 10c, the roughness of the aspherical mirror is measured by white light interferometry (Profilm3D). The maximum roughness observed is 0.14 um. Additionally, in FIG. 10(c), the mirror profile is measured using a profiler (DektakXT Stylus Profiler). This instrument utilizes a diamond-tip stylus that contacts the sample and measures the profile. The resolution of the measurement is 0.5 um/point. FIG. 10(d) presents a comparison between the experimental and theoretical profile heights of the major and minor axes. It is observed that there is a height difference between the experimental and theoretical profiles, exhibiting a wave-like oscillating structure every 3 cm. This discrepancy is attributed to potential errors in the CNC fabrication process.

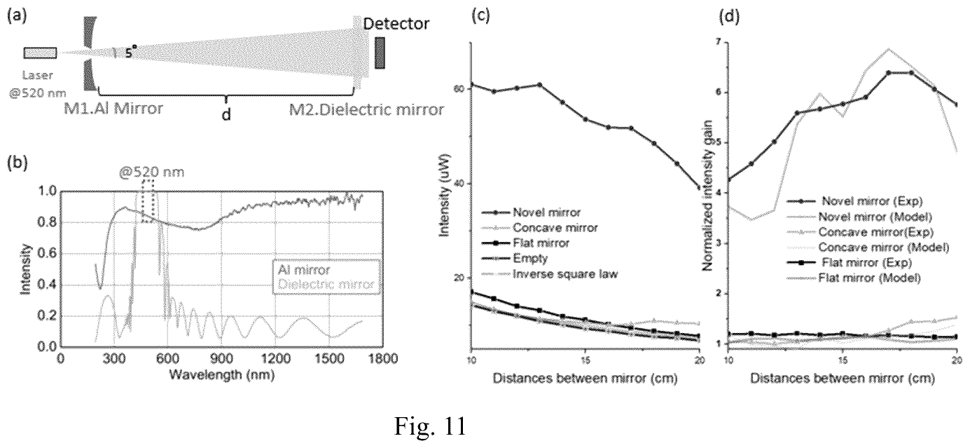

The aspherical mirror cavity's performance is then verified. In FIG. 11(a), a drawing of the setup is presented, illustrating the experimental measurement of the mirror cavity. The setup involved a green laser with a wavelength of 520 nm and a full cone angle of 5 degrees. The light was injected into the cavity through the center hole of a 2-inch mirror (M1), creating an optical cavity between M1 and M2. M2, a partially transparent mirror, had a square shape with dimensions of 7 cm by 7 cm. A photodetector with a 1 cm sensing area (Newport, model 818UV) was positioned after M2 to detect the light. The intensity was measured with respect to the change in distance between M1 and M2.

In FIG. 11(b), at a wavelength of 520 nm and an incident angle of 45 degrees, the measured reflectivity was approximately R(M1)=0.86 and R(M2)=0.99 (J A Wollam ellipsometer M2000). Since the experiment utilized a close-to-0 degree angle of incidence, the reflectivity was estimated to lie at R(M1)=0.9 and R(M2)=0.99. The geometric mean of the reflectance values of the two mirrors was calculated as R=\sqrt{R₁R₂} [1], resulting in an estimated value of approximately 0.94.

In FIG. 11(c), the experimental measurement of the mirror cavity setup is further explained, and four sets of measurements were conducted. The measurements included four cases: a). without M1 (mean without cavity case), replace M1 as b). flat mirror, c). concave mirror (Focal length=10 cm) and d). aspherical mirror. To verify the measurement accuracy, the without M1 case was compared to the inverse square law case, which showed a high level of agreement. The flat and concave mirrors exhibited a decay rate that closely followed the inverse square law. In contrast, the aspherical mirror showed a significantly lower decay rate.

In FIG. 11(d), the flat cavity data, the concave cavity data, and the aspherical mirror data were normalized with respect to the without mirror case. The simulation result, represented by a slightly transparent line, was also included. The data and simulation showed that the aspherical mirror could achieve a maximum enhancement of 4-6 times, while the flat and concave mirrors only achieved an enhancement of 1-1.5 times. It is worth noticing that the experimental result also matches the simulation result, even though the mirror has a significant manufacturing error, as shown in FIG. 11(d), which demonstrated its stability.

### E. Application

In this section, the potential of non-laser integrated cavity output spectroscopy is highlighted, emphasizing the cavity's tolerance of beam divergence and addressing the limitations of traditional multi-pass cells.

The two-mirror assembly enables enhanced light-matter interactions across diverse fields, including optical sensing, energy systems, and advanced photonics. The cavity's ability to maintain long optical path lengths supports high-sensitivity measurements and efficient energy transfer, applicable to optical processing and energy-efficient systems. Quasi-periodic trajectories minimize light escape, enhancing performance in environments requiring precise light control. Additionally, mirror rotation allows adjustable path lengths and beam patterns, facilitating applications in optical modulation and signal processing. This design's adaptability and stability position it as a foundational technology for next-generation optical systems.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

What is claimed is:

1. A mirror assembly, comprising:
a) a first mirror which is an aspherical mirror;
b) a second mirror located away from the first mirror; and
c) an open cavity formed between the first mirror and the second mirror.

2. The mirror assembly of claim 1, wherein the first mirror is a segment of a virtual ellipsoid that does not possess rotational symmetry.

3. The mirror assembly of claim 2, wherein the segment is centered at an intersection of a major axis and a minor axis of the ellipsoid.

4. The mirror assembly of claim 2, wherein the ellipsoid is a three-axis ellipsoid with three axes that are different in length between each other.

5. The mirror assembly of claim 1, wherein the open cavity has a caustic shape of a hyperbolic paraboloid.

6. The mirror assembly of claim 5, wherein ray trajectories within the open cavity are guided by the caustic shape in directions perpendicular to an optical axis of the open cavity.

7. The mirror assembly of claim 5, wherein a caustic of the open cavity oscillates in a major direction of the ellipsoid as well as in a minor direction of the ellipsoid that is perpendicular to the major direction.

8. The mirror assembly of claim 1, wherein the second mirror is an aspherical mirror.

9. An open cavity, comprising a caustic having shape of a hyperboloid of two sheets; the caustic oscillating only in a minor axis direction of an ellipsoid; the ellipsoid produced by revolving an ellipse about the major axis.

10. An open cavity, comprising a caustic having shape of a hyperboloid of one sheet; the caustic oscillating in two minor axis directions of an ellipsoid; the ellipsoid produced by revolving an ellipse about the minor axis.

11. An open cavity, comprising a caustic having shape of a hyperbolic paraboloid; the caustic oscillating in a major direction of the ellipsoid as well as a minor direction of the ellipsoid that is perpendicular to the major direction; the ellipsoid having no rotational symmetry.
